(19) United States
(12) Patent Application Publication
(10) Pub. No.: US 2011/0247568 A1
(43) Pub. Date: Oct. 13, 2011

(54) Horse Harness

(76) Inventors: Ronald Dean Pierce, Clarksburg, NJ (US); Terry Lynn Scott, Smyrna, DE (US)

(21) Appl. No.: 12/755,529

(22) Filed: Apr. 7, 2010

(51) Int. Cl. B68B 1/00

(52) U.S. Cl. 119/712

(57) ABSTRACT

A harness used for restraining a horse or other animal during training and grooming is disclosed. The harness consists of an upper strap connected to a lower strap. The strap is placed around the front legs of the horse by a buckle. The upper strap is placed over the front shoulder of the horse.

### BACKGROUND OF THE INVENTION

The present invention is directed to the field of harnesses for horses or other large animals. There are many available harnesses that can be used for a variety of purposes and reasons. The present invention is particularly directed to the field of harnesses that can be used to control the animal and keep it from moving so that a trainer or other worker can safely work on the horse for grooming or other tasks.

The available harnesses suffer from various defects that make them undesirable for restraining the horse's movements. The most prominent of such defects is that the horse's front legs are not controlled by the available harnesses. Consequently, it is difficult to control the animal's movements. The primary object of the present invention is cure this and other defects in the available harnesses by providing a simple, easy to use harness that can immobilize the front legs of the horse.

### SUMMARY OF THE INVENTION

A harness for controlling a horse or other animal comprising an upper belt with an adjustable height for placement on front shoulders of the horse or other animal and a lower belt with an adjustable circumference attached to the upper belt for placement around the front legs of the horse or other animal.

### BRIEF DESCRIPTION OF THE DRAWINGS

FIG. 1 is a perspective view of an embodiment of the present invention.

FIG. 2 is a side view of an embodiment of the present invention.

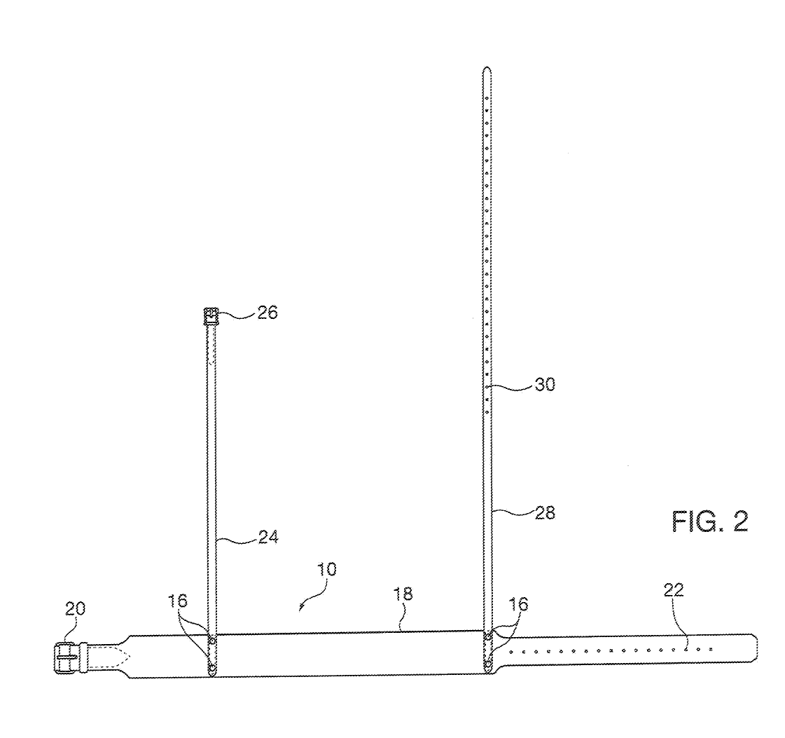

FIG. 3 is a perspective view of an embodiment of the present invention as installed on a horse.

### DETAILED DESCRIPTION OF THE INVENTION

The present invention will now be described in terms of the present preferred embodiment thereof as shown in the drawings.

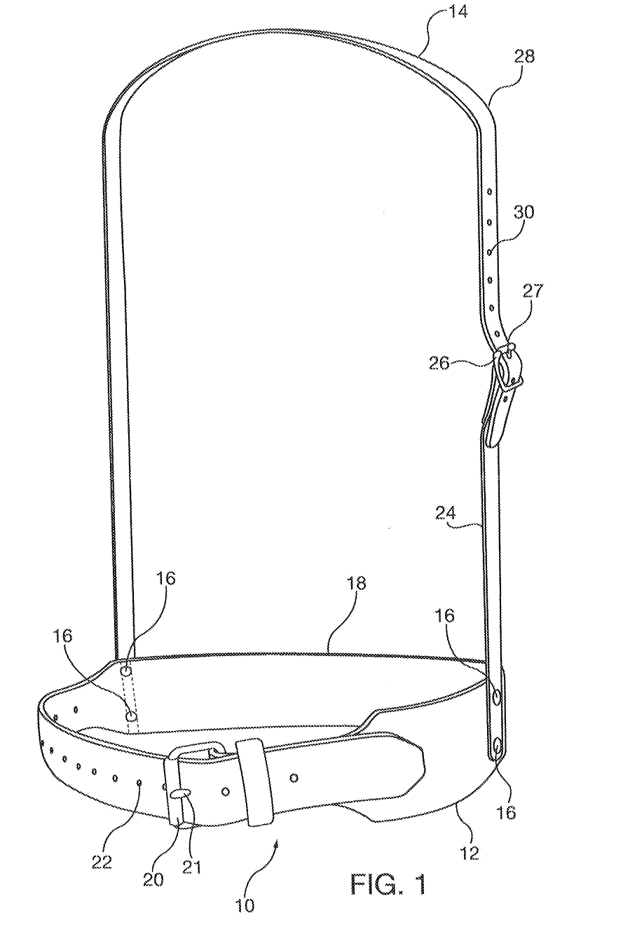

The harness 10 of the present invention is shown in FIG. 1. The harness 10 comprises a lower belt 12 and an upper belt 14. The upper belt 14 is fixed to the lower belt 12 by a plurality of suitable fasteners 16 such as rivets or other equivalent fastening means.

The lower belt 12 comprises a first strap 18 with an adjustable circumference. The circumference of the first strap 18 is adjustable by means of a first buckle 20 and a first buckle spike 21. As can be seen in FIG. 1, strap 18 comprises a first plurality of holes 22. The plurality of holes 22 are each adapted to receive the buckle spike 21. The circumference of the strap 18 is adjusted accordingly by placing the buckle spike 21 in one of the plurality of holes 22.

The upper belt 14 comprises a second strap 24 that is connected to a second buckle 26 with a second buckle spike 27. The upper belt 14 further comprises a third strap 28. The second strap 24 and the third strap 28 are affixed to the lower belt 12 by the plurality of fasteners 16. The third strap 28 comprises a second plurality of holes 30 which are each adapted to receive the second buckle spike 27. By selecting a particular hole 30, the height of the upper belt 14 can thereby be adjusted.

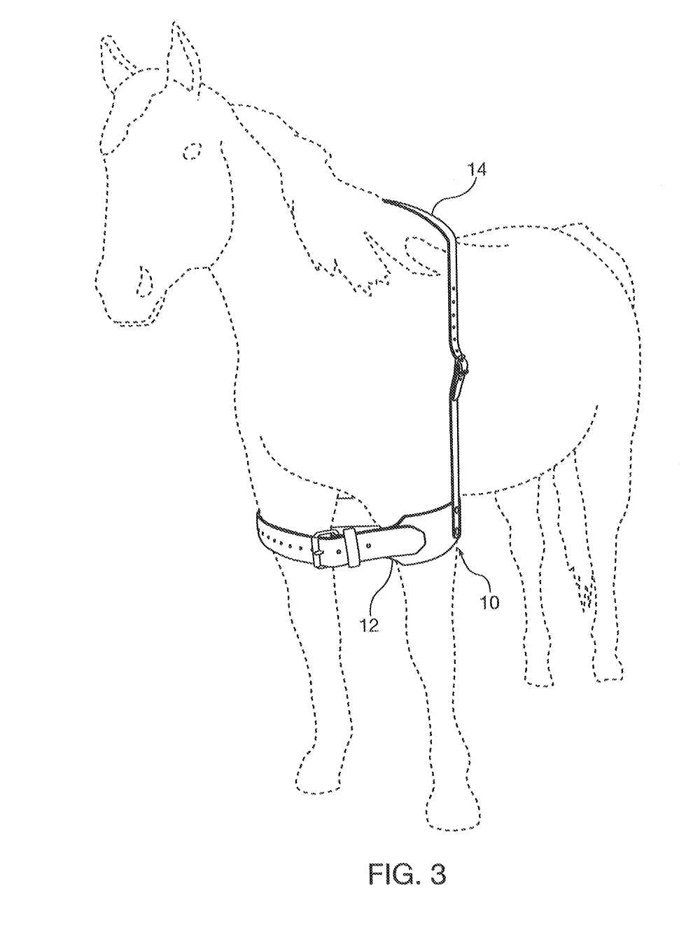

The placement of the harness 10 on a horse is illustrated in FIG. 3. As can be seen in FIG. 3, the upper belt 14 is placed on the front shoulders of the horse. The lower belt 12 is placed around the front legs of the horse. The circumference of the strap 18 is adjusted snugly around the front legs by adjusting the first buckle 20 to the appropriate hole 22. The height of the second belt 14 is adjusted snugly by means of the second buckle 26 to the appropriate hole 30. After the harness is placed on the horse in this manner the front legs of the horse are controlled by the user. Consequently, the horse is readily controllable while various tasks such as training and grooming are performed.

Those of ordinary skill in the art will recognize that the embodiments just described merely illustrate an embodiment of the present invention and many modifications may be made thereto without departing from the spirit and scope of the present invention as set forth in the appended claims.

What is claimed is:

1) A harness for controlling a horse or other animal comprising:
a) An upper belt with an adjustable height for placement on front shoulders of the horse or other animal;
b) A lower belt with an adjustable circumference attached to the upper belt for placement around the front legs of the horse or other animal;

2) The harness of claim 1 wherein the height of the upper belt is adjusted by means of a first buckle, a first spike and a first plurality of holes in the upper belt wherein the height is adjusted by selecting one of the plurality of holes and inserting the first spike into the selected hole.

3) The harness of claim 1 wherein the circumference and the lower belt is adjusted by means of a second buckle, a second spike and a second plurality of holes in the upper belt wherein the circumference is adjusted by selecting one of the plurality of holes.
